(19) United States
(12) Patent Application Publication
(10) Pub. No.: US 2012/0129393 A1
(43) Pub. Date: May 24, 2012

(54) INTEGRATED CONNECTOR

(76) Inventor: TIEN-TING PENG, Yonghe City (TW)

(21) Appl. No.: 12/948,790

(22) Filed: Nov. 18, 2010

(51) Int. Cl. H01R 13/648; H01R 24/00

(52) U.S. Cl. 439/607.01; 439/660

(57) ABSTRACT

The connector contains an insulating body, a base board, a first terminal set, and a second terminal set. The insulating body has a tongue piece and, parallel to the tongue piece, a chamber with a front opening for housing the base board. The base board has a differential terminal set conforming to a memory card transmission interface such as T-FLASH. On a top side of the base board, there are a number of first conduction terminals for connecting the first terminal set. Correspondingly, on a bottom side of the base board, there are a number of second conduction terminals for connecting the second terminal set.

### (a) TECHNICAL FIELD OF THE INVENTION

The present invention generally relates to integrated connectors, and more particular to a connector integrating at least a USB interface and a memory card interface such as T-FLASH.

### (b) DESCRIPTION OF THE PRIOR ART

There are various types of connectors, such as USB, SD, T-FLASH, etc., for establishing electrical connectivity between electronic devices for the exchange or transmission of information or signals. Conventionally, a connector is for a specific type of device. However, to access a T-FLASH card, currently a T-FLASH card reader is connected to a USB A female socket and the T-FLASH card is inserted in the card reader. Not only the T-FLASH card reader has to be purchased separately (and, could be misplaced easily), but also a USB interface is occupied.

### SUMMARY OF THE INVENTION

A major objective of the present invention is provide a novel connector as follows. The connector contains an insulating body, a base board, a first terminal set, and a second terminal set. The insulating body has a tongue piece extended to a front direction and, parallel to the tongue piece, a chamber with a front opening for housing the base board. The base board has a differential terminal set conforming to a memory card transmission interface such as T-FLASH. On a top side of the base board, there are a number of first conduction terminals for connecting the first terminal set by soldering or surface mount technology (SMT). Correspondingly, on a bottom side of the base board, there are a number of second conduction terminals for connecting the second terminal set conforming to the USB transmission interface, also by soldering or surface mount technology (SMT). Through the circuit separation by the first terminal set, the connector could be used to connect a USB plug and a T-FLASH card simultaneously without preparing a separate T-FLASH card reader, and the USB plug and the T-FLASH card could function simultaneously without interfering each other.

Another major objective of the present invention is to provide a novel connector as follows. The connector contains an insulating body having at least a tongue piece extended to a front direction and, parallel to the tongue piece, at least a chamber with a front opening for housing a base board. The base board has a differential terminal set conforming to a memory card transmission interface such as T-FLASH. On a top side of the base board, there are a number of first conduction terminals for connecting the first terminal set by soldering or surface mount technology (SMT). Correspondingly, on a bottom side of the base board, there are a number of second conduction terminals for connecting the second terminal set conforming to a memory card transmission interface, also by soldering or surface mount technology (SMT). The first conduction terminals further connects a third terminal set conforming to the USB transmission interface. The tongue piece is further embedded with a fourth terminal set conforming to the USB transmission interface. As described, three or more USB and T-FLASH interfaces could be stacked and integrated in a single connector. Through the circuit separation by the second terminal set, the connector could be used to connect multiple USB plugs and T-FLASH cards simultaneously, and the USB plugs and the T-FLASH cards could function simultaneously without interfering each other.

As such, the connector could be used to connect a USB plug and a T-FLASH card simultaneously without preparing a separate T-FLASH card reader, and the USB plug and the T-FLASH card could function simultaneously without interfering each other.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a connector according a first embodiment of the present invention.

FIG. 2 is a perspective break-down diagram showing the various components of the connector of FIG. 1.

FIG. 3 is a schematic sectional diagram showing the connector of FIG. 1.

FIG. 4 is a schematic sectional diagram showing a USB plug and a T-FLASH card are inserted into the connector of FIG. 1.

FIG. 5 is a perspective diagram showing a connector according a first embodiment of the present invention.

FIG. 6 is a perspective break-down diagram showing the various components of the connector of FIG. 5.

FIG. 7 is a schematic sectional diagram showing the connector of FIG. 5.

FIG. 8 is a schematic sectional diagram showing a USB plug and a T-FLASH card are inserted into the connector of FIG. 5.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

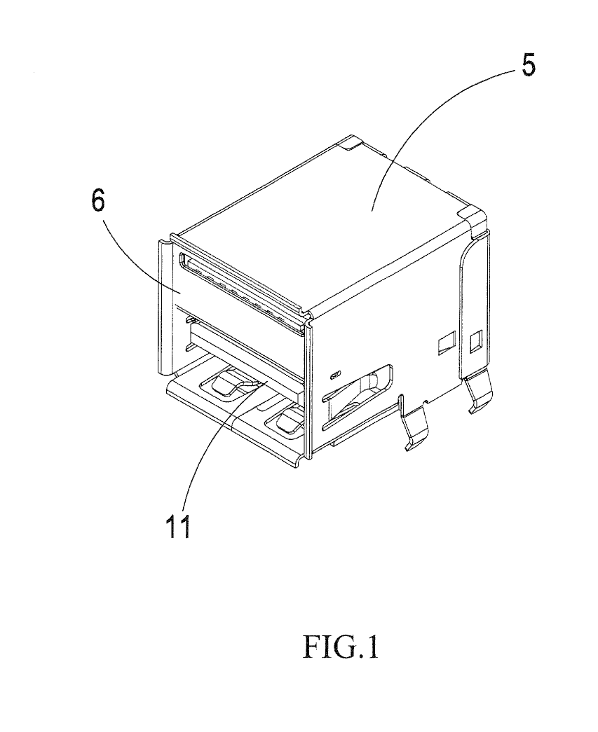

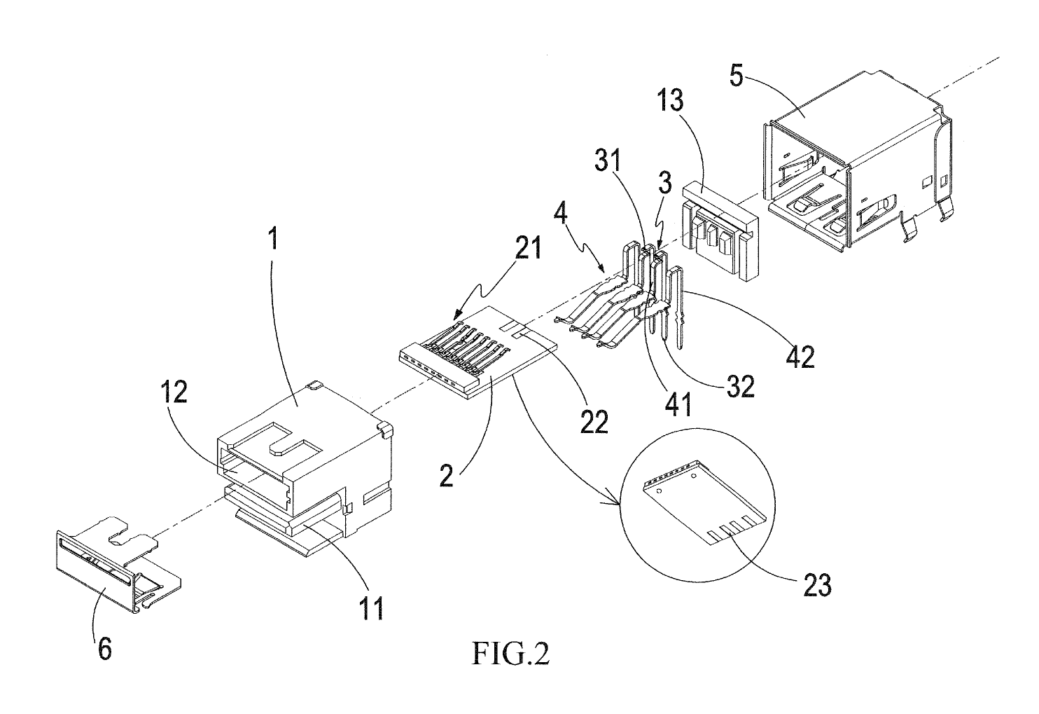

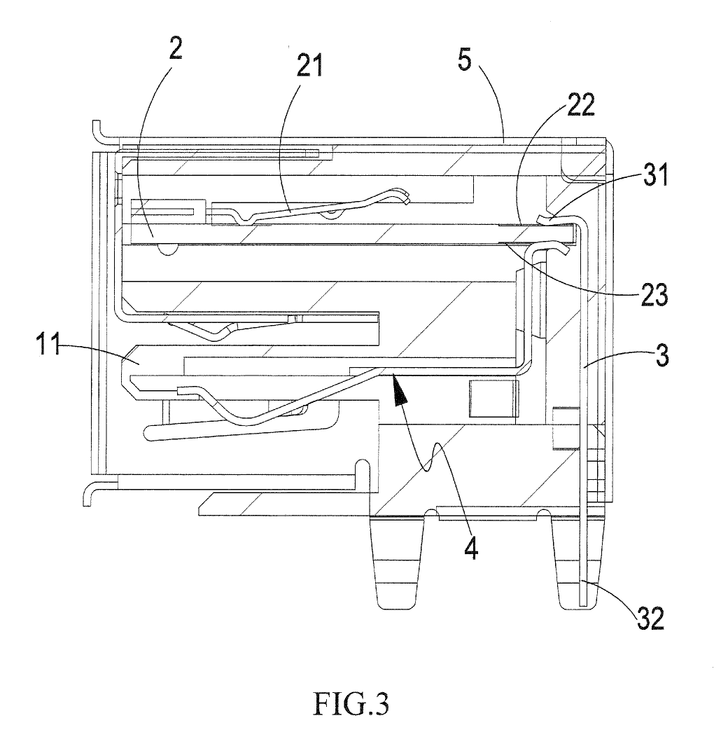

As shown in FIGS. 1 to 3, a connector according to first embodiment of the present invention mainly contains the following components.

An insulating body 1 has a tongue piece 11 flatly extended towards a front direction and, parallel to the tongue piece 11, a chamber 12 is provided with a front opening.

A base board 2 is housed in the chamber 12 and has a differential terminal set 21 conforming to a memory card transmission interface such as T-FLASH along a front edge. On a top side and along a back edge of the base board 2, there are a number of first conduction terminals 22. Correspondingly, on a bottom side and along the back edge, there are a number of second conduction terminals 23.

A first terminal set 3 is connected to the first conduction terminals 22 by soldering or by surface mount technology (SMT). Each of the first terminal set 3 has a first connecting section 31 connected to a first conduction terminal 22 and a first soldering section 32 connected to a circuit board 9.

A second terminal set 4, conforming to the USB transmission interface, is connected to the second conduction terminals 23 by soldering or by surface mount technology (SMT). Each of the second terminal set 4 has at least a first section 41 and at least a second section 42. The first section 41 is connected to a second conduction terminal 23, while the second section 42 is connected to the second conduction terminal at a specific location.

The insulating body 1 is itself housed in a shielding case 5. A locking piece 13 is configured on a back side of the insulating body 1 and a cover 6 is configured at the front opening of the chamber 12.

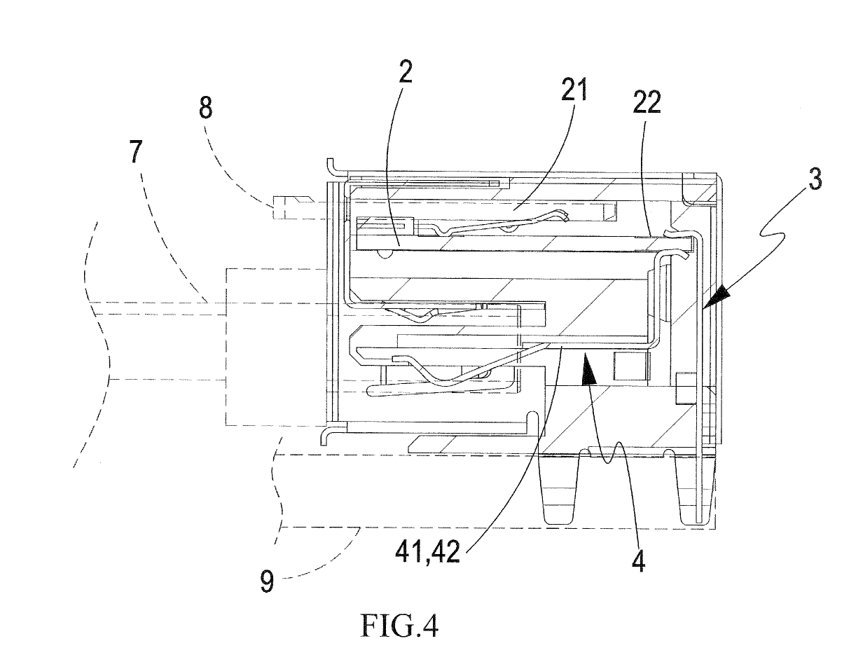

As shown in FIG. 4 where a USB plug 7 and a T-FLASH card 8 are simultaneously inserted into the connector of the present embodiment, the USB plug 7 is contacted and connected to the second terminal set 4 and data is exchanged through the first sections 41 and the second sections 42, and the base board 2 to the circuit board 9. On the other hand, the T-FLASH card 8 is contacted and connected to the differential terminal set 21 and data is exchanged through the first conduction terminals 22 and the first terminal set 3. Through the circuit separation by the first terminal set 3 connected to the first conduction terminals 22, both the USB plug 7 and the T-FLASH card 8 could function simultaneously.

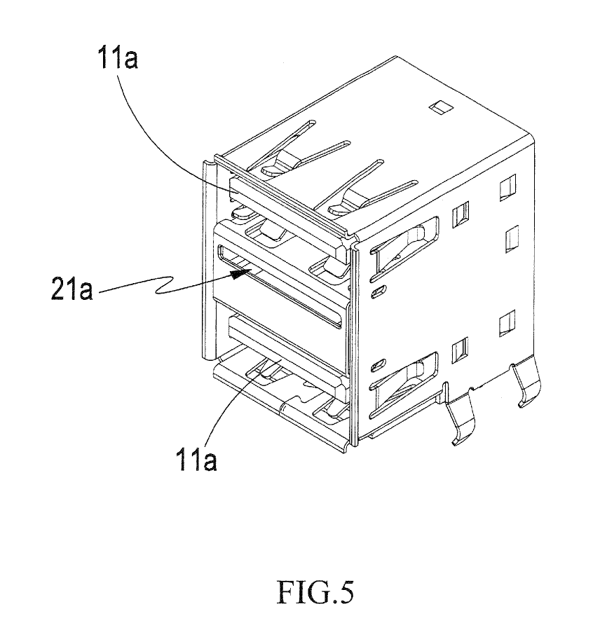

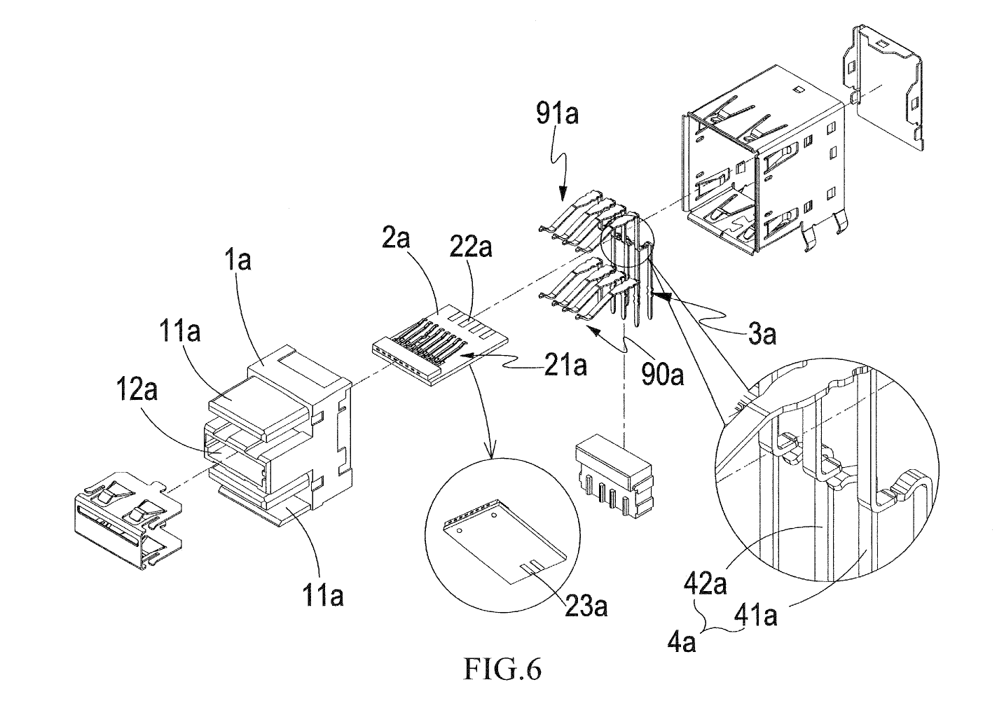

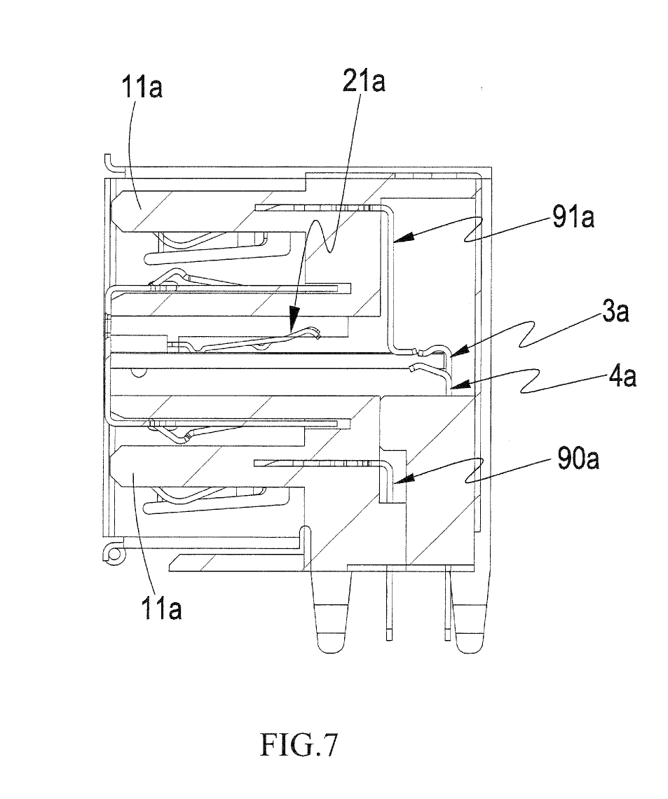

As shown in FIGS. 5 to 7, a connector according to second embodiment of the present invention mainly contains the following components.

An insulating body 1a has at least a tongue piece 11a flatly extended towards a front direction and, parallel to the tongue pieces 11a, a chamber 12a is provided with a front opening. A fourth terminal set 90a and a third terminal set 91a, both conforming to the USB transmission interface, are embedded into the tongue pieces 11a, respectively.

A base board 2a is housed in the chamber 12a and has a differential terminal set 21a conforming to a memory card transmission interface such as T-FLASH along a front edge. On a top side and along a back edge of the base board 2a, there are a number of first conduction terminals 22a. Correspondingly, on a bottom side and along the back edge, there are a number of second conduction terminals 23a. The first conduction terminals 22a are connected to the third terminal set 91a by soldering or by surface mount technology (SMT).

A first terminal set 3 is connected to the first conduction terminals 22.

A second terminal set 4a, conforming to a memory card transmission interface such as I-FLASH, is connected to the second conduction terminals 23a. Each of the second terminal set 4a has at least a first section 41a and a second section 42a, connected to a second conduction terminal 23a.

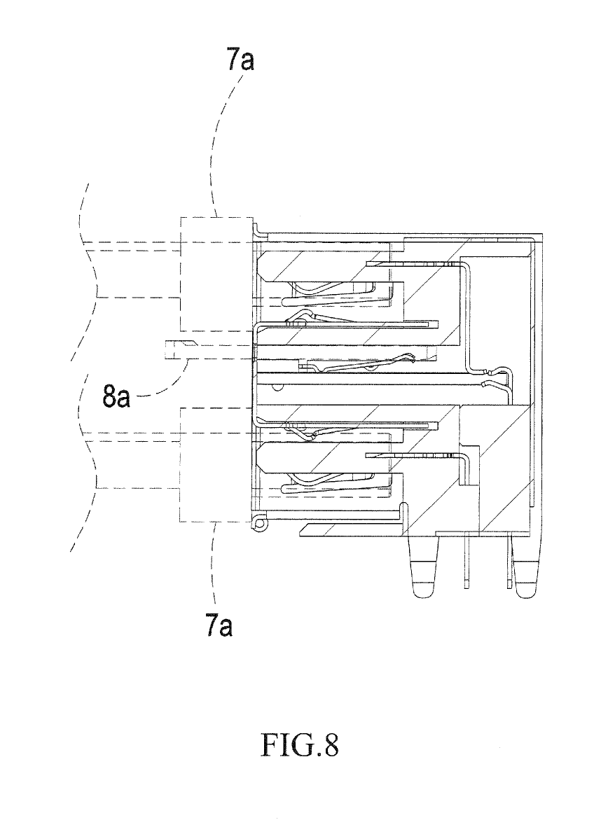

As shown in FIG. 8 where two USB plugs 7a and a T-FLASH card 8 are simultaneously inserted into the connector of the present embodiment, the lower USB plug 7a is contacted and connected to the fourth terminal set 90a. The T-FLASH card 8 is contacted and connected to the differential terminal set 21a and data is exchanged through the second terminal set 4a to a circuit board 9a. On the other hand, the upper USB plug 7a are contacted and connected to the third terminal set 91a and data is exchanged through the base board 2a to the circuit board 9a. As such, the two USB plugs 7a and the T-FLASH card 8 could function simultaneously.

As described above, the present invention has the following advantages.

Firstly, there is no need to purchase and prepare a T-FLASH card reader and the T-FLASH card could be directly plugged into a connector of the present invention.

Secondly, through circuit separation, the USB and T-FLASH could function simultaneously without mutual interference.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A connector for medical lighting, comprising:
an insulating body having a tongue piece extended towards a front direction and a chamber having a front opening;
a base board housed in said chamber, said base board having a differential terminal set conforming a memory card transmission interface where a plurality of first conduction terminals are provided on a top side and a plurality of second conduction terminals are provided on a bottom side;
a first terminal set connected to said first conduction terminals; and
a second terminal set connected to said second conduction terminals.

2. The connector according to claim 1, wherein said memory card transmission interface is a T-FLASH interface.

3. The connector according to claim 1, wherein said second terminal set conforms to the USB transmission interface.

4. The connector according to claim 1, wherein said second terminal conforms to a memory card transmission interface.

5. The connector according to claim 1, wherein each of said first terminal set has a first connecting section connected to a first conduction terminal and a first soldering section connected to a circuit board.

6. The connector according to claim 1, wherein each of said second terminal set has at least a first section connected to a second conduction terminal and at least a second section connected to said second conduction terminal at a specific location.

7. The connector according to claim 1, wherein each of said second terminal set has at least a first section and at least a second section, both connected to a second conduction terminal.

8. The connector according to claim 1, wherein said first conduction terminals is connected to a third terminal set conforming to the USB transmission interface.

9. The connector according to claim 1, wherein said tongue piece is embedded with a fourth terminal set conforming to the USB transmission interface.

10. The connector according to claim 1, wherein said first terminal set is connected to said first conduction terminals by soldering or surface mount technology.

11. The connector according to claim 1, wherein said second terminal set is connected to said second conduction terminals by soldering or surface mount technology.

12. The connector according to claim 8, wherein said third terminal set is connected to said first conduction terminals by soldering or surface mount technology.

13. The connector according to claim 1, wherein said insulting body is housed in a shielding case.

14. The connector according to claim 1, wherein a locking piece is configured on a back side of said insulating body.

15. The connector according to claim 1, wherein a cover is configured at said front opening of said chamber.
